(19) United States
(12) Patent Application Publication
(10) Pub. No.: US 2013/0307747 A1
(43) Pub. Date: Nov. 21, 2013

(54) VEHICULAR ANTENNA

(71) Applicant: DENSO CORPORATION, Kariya-city (JP)

(72) Inventor: Shiro Koide, Kariya-city (JP)

(73) Assignee: DENSO CORPORATION, Kariya-city (JP)

(21) Appl. No.: 13/894,775

(22) Filed: May 15, 2013

(30) Foreign Application Priority Data
May 18, 2012 (JP) 2012-114853

(51) Int. Cl. H01Q 1/52

(52) U.S. Cl. CPC H01Q 1/525
USPC 343/853

(57) ABSTRACT

A vehicular antenna includes a transmitting antenna element, a receiving antenna element, a coupling portion, and an adjusting portion. The transmitting antenna element transmits a radio wave as a transmission wave. The receiving antenna element receives a radio wave as a receiving wave. The coupling portion electromagnetically couples a transmitting line through which the transmission wave passes with a receiving line through which the receiving wave passes. The adjusting portion adjusts, within the coupling portion, a mutual coupling amount between the transmission wave in the transmitting line and the receiving wave in the receiving line. The adjusting portion further adjusts a phase of the transmission wave to be coupled with the receiving wave by the coupling portion.

### CROSS REFERENCE TO RELATED APPLICATION

This application is based on Japanese Patent Application No. 2012-114853 filed on May 18, 2012, the disclosure of which is incorporated herein by reference.

### TECHNICAL FIELD

The present disclosure relates to a vehicular antenna, which is equipped to a vehicle and reduces a mutual electromagnetic interference between a transmitting antenna element and a receiving antenna element.

### BACKGROUND

Conventionally, in order to avoid a mutual radio wave interference, a transmitting antenna element and a receiving antenna element are arranged such that a polarization plane of the transmitting antenna element is perpendicular to a polarization plane of the receiving antenna element. With this configuration, the transmitting antenna element and the receiving antenna element are isolated from each other.

Further, a technology for attenuating a radio wave, which is transmitted from the transmitting antenna element and is mixed in the radio wave to be received by the receiving antenna element, by inserting a filter between the receiving antenna element and a receiver.

Further, as disclosed in JP 2011-160339 A, in a vehicular wireless communication system, a transmitting antenna element is arranged apart from a receiving antenna element in order to isolate the antenna elements from each other. Further, the transmitting antenna element is arranged at a directional null point of the receiving antenna element, and the receiving antenna element is arranged at a direction null point of the transmitting antenna element.

Each antenna element is arranged based on a directionality thereof so that the polarization plane of the transmitting antenna element is perpendicular to the polarization plane of the receiving antenna element. With this arrangement, it is difficult to obtain an intended directionality of each antenna element. Further, a position to arrange each antenna element is limited, which cause a difficulty in reduction in size.

In the configuration where the filter is inserted in the receiving line in order to remove an interference wave generated by an interference between the transmitting antenna element and the receiving antenna element, when a frequency of the interference wave is close to a frequency of an expected wave, the expected wave is also attenuated by the filter causing a reduction in a carrier to noise ratio (C/N). Hereinafter, the interference wave is also referred to as a noise wave.

Further, in the 2011-160339 A, the transmitting antenna element and the receiving antenna element need to be arranged apart from each other. Thus, when using as a vehicular antenna, reduction in size is difficult to be achieved. Further, since the antenna elements need to be mounted apart from each other, mounting work efficiency is degraded.

### SUMMARY

In view of the foregoing difficulties, it is an object of the present disclosure to provide a vehicular antenna, which has a transmitting antenna element and a receiving antenna element arranged adjacent to each other and having an improved receiving sensitivity and a compact simplified structure.

According to an aspect of the present disclosure, a vehicular antenna includes a transmitting antenna element, a receiving antenna element, a coupling portion, and an adjusting portion. The transmitting antenna element transmits a radio wave, which is also referred to as a transmission wave. The receiving antenna element receives a radio wave, which is also referred to as a receiving wave. The coupling portion electromagnetically couples a transmitting line through which the transmission wave passes with a receiving line through which the receiving wave passes. The transmitting line couples the transmitting antenna element to a transmitter, and the receiving line couples the receiving antenna element to a receiver. The adjusting portion adjusts, within the coupling portion, a mutual coupling amount between the transmission wave in the transmitting line and the receiving wave in the receiving line. The adjusting portion further adjusts a phase of the transmission wave to be coupled with the receiving wave by the coupling portion.

With the above vehicular antenna, when the transmitting antenna element and the receiving antenna element are arranged adjacent to each other, the vehicular antenna has an improved receiving sensitivity and a compact simplified structure.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of a vehicular antenna according to an embodiment of the present disclosure;

FIG. 2 is a diagram showing a configuration of a coupling portion and an adjusting portion according to a first embodiment of the present embodiment;

FIG. 3 is a diagram showing a configuration of a coupling portion and an adjusting portion according to a second embodiment of the present disclosure; and

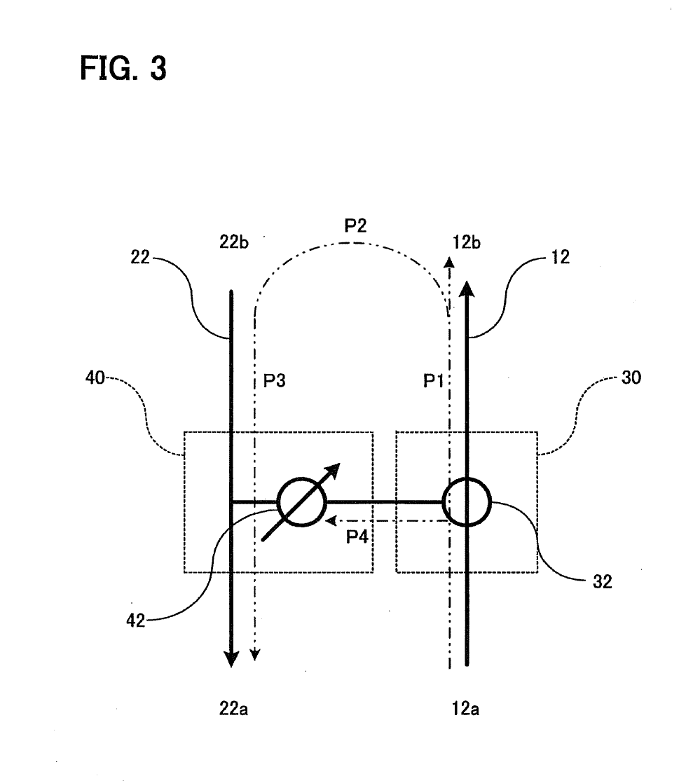

FIG. 4 is a diagram showing a configuration of a coupling portion and an adjusting portion according to a third embodiment of the present disclosure.

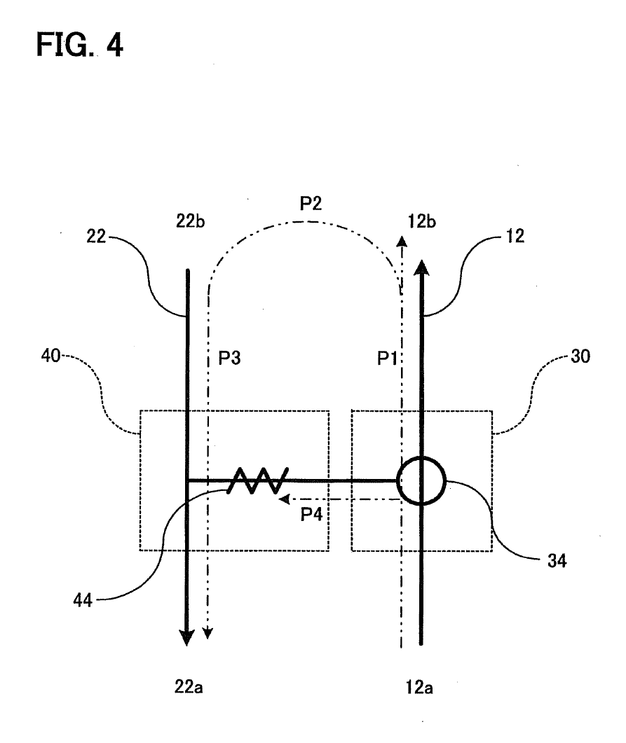

### DETAILED DESCRIPTION

The following will describe embodiments of the present disclosure with reference to the drawings.

### First Embodiment

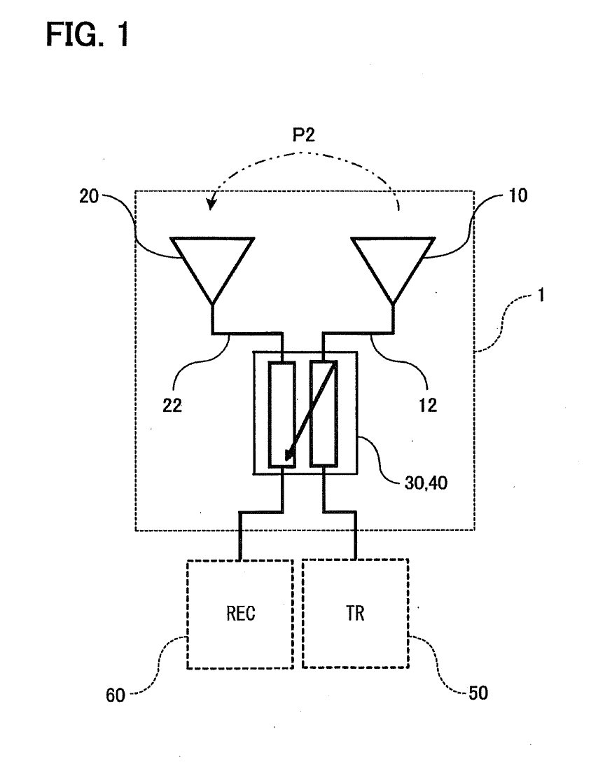

As shown in FIG. 1, a vehicular antenna 1 includes a transmitting antenna element 10, a transmitting line 12, a receiving antenna element 20, a receiving line 22, a coupling portion 30, and an adjusting portion 40.

The transmitting antenna element 10 transmits radio waves. For example, the transmitting antenna element 10 may be provided by a microstrip patch antenna or a horn antenna based on a power and a frequency of the radio wave transmitted from the transmitting antenna element 10. The transmitting line 12 electromagnetically couples the transmitting antenna element 10 to a transmitter (TR) 50. For example, the transmitting line 12 may be provided by a coaxial cable or a waveguide.

The receiving antenna element 20 receives radio waves. For example, similar to the transmitting antenna element 10, the receiving antenna element 20 may be provided by a microstrip patch antenna or a horn antenna based on a power and a frequency of the radio wave received by the receiving antenna element 20.

The receiving line 22 electromagnetically couples the receiving antenna element 20 to a receiver (REC) 60. Similar to the transmitting line 12, the receiving line 22 may be provided by, for example, a coaxial cable or a waveguide. The coupling portion 30 electromagnetically couples the transmitting line 12 and the receiving line 22.

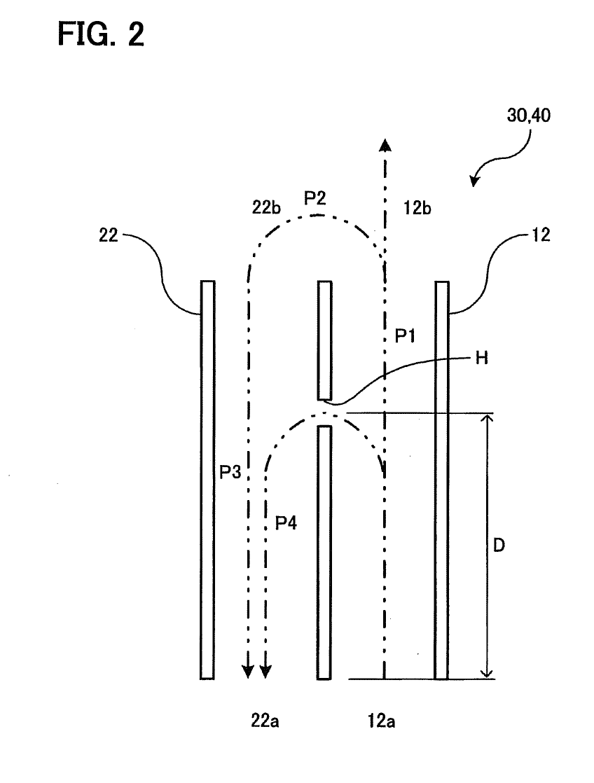

The following will describe an exemplary structure of the coupling portion 30 and the adjusting portion 40 with reference to FIG. 2. As shown in FIG. 2, the coupling portion 30 and the adjusting portion 40 according to the present embodiment are provided by a part of the transmitting line 12 and a part of the receiving line. 22, which are provided by respective rectangular waveguides. Hereinafter, the transmission line 12 is also referred to as a transmission waveguide, and the receiving line 22 is also referred to as a receiving waveguide.

As shown in FIG. 2, in the coupling portion 30, the transmitting line 12 is arranged, together with the receiving line 22, on a plane that contains an electric field vector of the radio wave passing through the transmitting line 12. The plane contains the electric field vector is also known as E-plane. The transmitting line 12 defines a through hole H, which connects the transmission waveguide and the receiving waveguide. The hole H functions as the adjusting portion 40. The hole is arranged apart from an end of a port 12a, which will be described later, by a predetermined distance D.

As shown in FIG. 1 and FIG. 2, the vehicular antenna 1 includes the port 12a arranged between the transmitter 50 and the transmitting line 12, a port 12b arranged between the transmitting line 12 and the transmitting antenna element 10, a port 22a arranged between the receiver 60 and the receiving line 22, a port 22b arranged between the receiving line 22 and the receiving antenna element 22.

With above-described configuration, as shown in FIG. 2, the radio wave P1 output from the transmitter 50 passes through the port 12a and the port 12b, and is transmitted toward outside from the transmitting antenna element 10. Hereinafter, the radio wave output from the transmitter 50 is also referred to as a transmission wave, and the radio wave received by the receiver 60 is also referred to as a receiving wave. In some cases, the transmission wave P2 is mixed in the receiving waves as a noise for reasons such as the arrangement in which the antenna elements 12, 22 are arranged adjacent to each other. As shown in FIG. 2, the transmission wave P2 mixed in the receiving waves passes from the port 22b to the port 22a as a noise wave P3.

When the transmission waves are output from the transmitter 50, most part of the transmission waves pass from the port 12a to the port 12b. However, a part of the transmission waves pass through the hole H defined on the transmission waveguide, and pass to the receiving waveguide. Hereinafter, the transmission wave passing through the hole H are also referred to as a leakage wave P4.

The noise wave P3 passing toward the port 22b is added to the leakage wave P4. Thus, the position of the hole H, that is the distance D from the end of the port 12a to the hole H, is adjusted such that a phase of the noise wave P3 is opposite to a phase of the leakage wave P4. Further, a size of the hole H is adjusted such that a power of the noise wave P3 is the same with a power of the leakage wave P4. By this configuration, the noise wave P3 is compensated by the leakage wave P4.

When a part of the transmission waves are mixed in the receiving waves as the noise waves, the noise waves are avoided to be received by the receiver 60 by the above-described configuration. By the above-described configuration, the adjusting portion 40 adjusts a mutual wave coupling amount between the transmission waves passing through the transmitting line 12 and the receiving waves passing through the receiving line 22. Further, the adjusting portion 40 adjusts a phase of the wave passing from the transmission line 12 to the receiving line 22 through the hole H.

In FIG. 2, the position of the hole H is variable in a direction toward the transmitting antenna element 10 or in a direction toward the transmitter 50. The position of the hole H is adjusted such that a phase of a propagated wave, which is input from the port 12a and output from the port 12b and mixes in the receiving waves from the port 22b and passes to the port 22a, is opposite to a phase of the leakage wave, which is input from the port 12a and leaked toward the receiving line 22 via the hole H, at the position of the hole H.

Further, the size of the hole H is adjusted such that the noise wave P3 and the leakage wave P4 have the same power. With this configuration, the noise wave P4 is avoided to be received by the receiver 60. As described above, the coupling portion 30 electromagnetically couples the transmitting line 12 and the receiving line 22.

Further, the mutual wave coupling amount between the transmitting line 12 and the receiving line 22 included in the coupling portion 30 is adjusted to be the same with a mutual wave coupling amount between the transmitting antenna element 10 and the receiving antenna element 20 by the adjusting portion 40. Further, a phase of the transmission wave (leakage wave), which passes through the hole H toward the receiving line 22, is adjusted to be opposite to the transmission wave (noise wave), which is mixed in the receiving waves, by the adjusting portion 40. Thus, the adjusting portion 40 reduces the noise waves.

Even when the transmitting antenna element 10 is arranged adjacent to the receiving antenna element 20, the interference wave (noise wave) passing from the transmitting antenna element 10 to the receiving antenna element 20 is avoided to be received by the receiver 60. Thus, a receiving sensitivity of the vehicular antenna 1 is improved.

In the conventional vehicular antenna, the noise wave is avoided by inserting the filter in the receiving line. In the vehicular antenna 1 according to the present embodiment, the noise wave is avoided to be received by the receiver 60 without inserting the filter in the receiving line 22. Thus, the receiving sensitivity is improved. In the conventional vehicular antenna, the arrangement of the transmitting and receiving antenna elements are limited based on a directionality. In the vehicular antenna 1 according to the present embodiment, an arrangement of the antenna elements 10, 20 are not restricted by any limitations. That is, the antenna elements 10, 20 have no need to be arranged apart from each other. Thus, the vehicular antenna 1 is reduced in size. Further, the noise wave is restricted by the coupling portion 30 and the adjusting portion 40, which have a simplified compact configuration.

### Second Embodiment

The following will describe a vehicular antenna 1 according to a second embodiment of the present disclosure. In the vehicular antenna 1 according to the second embodiment, a configuration of the coupling portion 30 and the adjusting portion 40 is different from the first embodiment. The structure of the vehicular antenna 1 according to the present embodiment is similar to the structure of the vehicular antenna 1 according to the first embodiment except the coupling portion 30, the adjusting portion 40, the transmitting line 12 and the receiving line 22. The following will describe a configuration of the vehicular antenna 1 according to the present embodiment.

In the present embodiment, the transmitting line 12 and the receiving line 22 are provided by respective coaxial cables. Further, the coupling portion 30, which is provided by a distributor 32, is arranged at a portion of the transmitting line 12. The distributor 32 distributes a part of the transmission waves to the receiving line 22. Further, the adjusting portion 40, which is provided by a phase shifter 42, is arranged at a portion of the receiving line 22. The phase shifter 42 shifts a phase of the transmission wave distributed by the distributor 32.

In the coupling portion 30 and the adjusting portion 40 according to the present embodiment, the distributor 32, which functions as the coupling portion 30, distributes a transmission wave as a distribution wave P4 to the phase shifter 42, which functions as the adjusting portion 40. Further, in the phase shifter 42, a phase of the distribution wave P4 is adjusted to be opposite to the noise wave P3. Then, the adjusted distribution wave P4 is added to the receiving waves passing through the receiving line 22.

With above-described configuration, the radio wave P2, which is transmitted from the transmitting antenna element 10 and mixed in the receiving waves and received by the receiving antenna element 20, is restricted to be received by the receiver 60, similar to the vehicular antenna 1 according to the first embodiment.

Further, the coupling portion 30 and the adjusting portion 40 in the present embodiment are provided, respectively, by the distributor 32 that distributes a part of the transmission waves to the receiving lines 22 and the phase shifter 42 that shifts a phase of the distributed wave distributed by distributor 32. Thus, a configuration of the coupling portion 30 and the adjusting portion 40 is simplified, and the coupling portion 30 and the adjusting portion 40 are reduced in size.

The coupling portion 30 and the adjusting portion 40 according to the present embodiment are simplified and are reduced in size. Accordingly, the vehicular antenna 1 according to the present embodiment is simplified in configuration and reduced in size. That is, vehicular antenna 1 has a compact simplified structure.

### Third Embodiment

The following will describe a vehicular antenna 1 according to a third embodiment of the present disclosure. In the vehicular antenna 1 according to the third embodiment, a configuration of the coupling portion 30 and the adjusting portion 40 is different from the second embodiment. The structure of the vehicular antenna 1 according to the present embodiment is similar to the structure of the vehicular antenna 1 according to the second embodiment except the coupling portion 30 and the adjusting portion 40. The following will describe the coupling portion 30 and the adjusting portion 40 according to the present embodiment.

In the present embodiment, the coupling portion 30 is arranged at a portion of the transmitting line 12. The coupling portion 30 is provided by a magic tee 34, which is one type of a distributor. The magic tee 34 distributes a part of the transmission waves to the receiving line 22. The magic tee 34 has an E-plane port. Thus, a post-distribution wave, which is distributed by the magic tee 34 and passes toward the receiving line 22, has a phase opposite to a phase of a pre-distribution wave, which is input from the port 12a toward the transmitting line 12.

Further, the adjusting portion 40 is arranged at a portion of the receiving line 22. The adjusting portion 40 is provided by an attenuator 44. The attenuator 44 adjusts an attenuation amount of the distributed wave, which is distributed by the magic tee 34.

In the coupling portion 30 and the adjusting portion 40 according to the present embodiment, the magic tee 34, which functions as the coupling portion 30, distributes a part of the transmission waves as a distribution wave P4 and transmits the distribution wave P4 to the attenuator 44, which functions as the adjusting portion 40.

Further, in the attenuator 44, a power of the distribution wave P4 is attenuated to have the same power with the noise wave P3. Then, the attenuated distribution wave P4 is added to the receiving waves passing through the receiving line 22.

With above-described configuration, the radio wave P2, which is transmitted from the transmitting antenna element 1 and mixed in the receiving waves and received by the receiving antenna element 20, is restricted to be received by the receiver 60, similar to the vehicular antenna 1 according to the first embodiment.

In the present embodiment, the coupling portion 30, which is provided by the magic tee 34, distributes a part of the transmission waves as the distribution wave and reverses the phases of the distribution wave. Further, the adjusting portion 40, which is provided by the attenuator 44, attenuates the power of the distribution wave and transmits the distribution wave to the receiving line 22. Thus, a configuration of the coupling portion 30 and the adjusting portion 40 is simplified and the coupling portion 30 and the adjusting portion 40 are reduced in size.

Thus, the coupling portion 30 and the adjusting portion 40 according to the present embodiment are simplified and are reduced in size. Accordingly, the vehicular antenna 1 according to the present embodiment is simplified in configuration and is reduced in size. That is, the vehicular antenna 1 according to the present embodiment has a compact simplified structure.

In the foregoing embodiments, the coupling portion 30 is provided by the rectangular waveguide. Further, the coupling portion 30 may be provided by a substrate pattern like a microstrip. When the coupling portion 30 is provided by the substrate pattern, the coupling portion 30 can be further reduced in size.

Further, when a patterned substrate is used in the vehicular antenna 1, the transmitting line 12 and the receiving line 22 may be provided by the substrate pattern, and the transmitting antenna element 10 and the receiving antenna element 20 may be provided by patch antennas or pattern antennas. With this configuration, the whole vehicular antenna 1 can be arranged on one substrate, and the vehicular antenna 1 can be further reduced in size.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A vehicular antenna comprising:
a transmitting antenna element that transmits a radio wave, which is also referred to as a transmission wave;
a receiving antenna element that receives a radio wave, which is also referred to as a receiving wave;
a coupling portion that electromagnetically couples a transmitting line through which the transmission wave passes with a receiving line through which the receiving wave passes, the transmitting line coupling the transmitting antenna element to a transmitter and the receiving line coupling the receiving antenna element to a receiver; and
an adjusting portion that adjusts, within the coupling portion, a mutual coupling amount between the transmission wave in the transmitting line and the receiving wave in the receiving line, the adjusting portion further adjusting a phase of the transmission wave to be coupled with the receiving wave by the coupling portion.

2. The vehicular antenna according to claim 1,
wherein the coupling portion is provided by a distributor,
wherein the distributor distributes the transmission wave to be coupled with the receiving wave from the transmitting line to the receiving line,
wherein the adjusting portion is provided by a phase shifter, and
wherein the phase shifter shifts the phase of the transmission wave, which is to be coupled with the receiving wave and is distributed by the distributor.

3. The vehicular antenna according to claim 1,
wherein the coupling portion is provided by a magic tee,
wherein the magic tee distributes the transmission wave to be coupled with the receiving wave from the transmitting line to the receiving line,
wherein the adjusting portion is provided by an attenuator, and
wherein the attenuator attenuates the transmission wave, which is to be coupled with the receiving wave and is distributed by the magic tee.
